(19) United States
(12) Patent Application Publication
(10) Pub. No.: US 2006/0255142 A1
(43) Pub. Date: Nov. 16, 2006

(54) Methods and apparatus for shock protection

(76) Inventors: Edward Barkan, Miller Place, NY (US); Mark Drzymala, Commack, NY (US); John Potter, Shirley, NY (US)

Correspondence Address: FAY KAPLUN & MARCIN, LLP, 15O BROADWAY, SUITE 702, NEW YORK, NY, 10038, US

(21) Appl. No.: 11/130,729

(22) Filed: May 16, 2005

(51) Int. Cl. G06K 7/10

(52) U.S. Cl. 235/454; 235/462.43

(57) ABSTRACT

Methods and apparatus for providing shock protection. An exemplary scan engine comprises flexures in a scan motor that should be protected in shock events. Elements of a scan module, such as, for example, a shock protection module comprising extending members, a scan mirror, etc. can contact a soft stop in a shock event. The soft stop can be an over mold section of the flexure or a soft coating around the scan mirror.

### FIELD OF THE INVENTION

The invention is directed to laser scanners and, more particularly to shock protection of scan module components.

### BACKGROUND OF THE INVENTION

There are numerous standards for encoding numeric and other information in visual form, such as the Universal Product Codes (UPC) and/or European Article Numbers (EAN). These numeric codes allow businesses to identify products and manufactures, maintain vast inventories, manage a wide variety of objects under a similar system and the like. The UPC and/or EAN of the product is printed, labeled, etched, or otherwise attached to the product as a dataform.

Dataforms are any indicia that encode numeric and other information in visual form. For example, dataforms can be barcodes, two dimensional codes, marks on the object, labels, signatures, signs etc. Barcodes are comprised of a series of light and dark rectangular areas of different widths. The light and dark areas can be arranged to represent the numbers of a UPC. Additionally, dataforms are not limited to products. They can be used to identify important objects, places, etc. Dataforms can also be other objects such as a trademarked image, a person's face, etc.

Scanners that can read and process the dataforms have become common and come in many forms and varieties. One embodiment of a scanning system resides, for example, in a hand-held gun shaped, laser scanning device. A user can point the head of the scanner at a target object and press a trigger to emit a light beam that is used to read, for example, a dataform, on the object. Another example is a scan engine, which is a self contained scanning module that can be added to different devices to give the devices scanning capabilities.

In an embodiment, semiconductor lasers are used to create the light beam because they can be small in size, they are low in cost and they do not require a lot of power. One or more laser light beams can be directed by a lens or other optical components along a light path toward an object that includes a dataform. The light path comprises scan elements including a pivoting scan mirror that sweeps the laser light back and forth across the object and/or dataform. The mirror can be part of a scan motor comprising a flexure, also known as a spring, and a permanent magnet. Flexures are used to pivot the mirror instead of bearings, because bearings wear out faster, thus making them less reliable.

The magnet is positioned in the vicinity of a drive coil, which oscillates the scan motor. There are numerous other known methods of sweeping the laser light, such as moving the light source itself or illuminating a plurality of closely spaced light sources in sequence to create a sweeping scan line. The scanner can also create other scan patterns, such as, for example, an ellipse, a curved line, a two or three dimensional pattern, etc.

The scanner also comprises a sensor or photodetector for detecting light reflected or scattered from an object and/or dataform. The returning light is then analyzed to obtain data from the object or dataform.

Scanners are often housed in portable or handheld equipment that can occasionally experience severe shock from being dropped, knocked off tables, etc. Therefore, it is important to protect the delicate components of a scan module from these and other types of shocks. For example, the flexures of a scan motor can become overstressed or bent permanently out of shape if not constrained during a shock event.

In existing scan modules, flexures are protected from damage from shocks by installing mechanical stops closely spaced around the moving mount on which the scan mirror is attached. During a shock, the flexure bends until the mirror mount hits one of the stops. The stops are positioned to stop the motion of the mirror mount before the flexure is damaged from being over-stressed. See, for example, U.S. Pat. Nos. 5,945,659 and 5,917,173, both of which are owned by Symbol Technologies, Inc.

Due to space constraints, sometimes stops are positioned in the light path of either the outgoing laser beam or the laser light that is reflected/scattered off the dataform. In either case, the position of the stop can degrade the scanner's performance. Accordingly, there is a desire for methods and apparatus for protecting scan module components from shock events by implementing stops that do not block the light path.

### SUMMARY OF THE INVENTION

The invention as described and claimed herein satisfies this and other needs, which will be apparent from the teachings herein.

An exemplary shock protection system comprises a dynamic substrate and a soft stop. The dynamic substrate comprises a shock protection module that can contact the soft stop in a shock event and impede the motion of the dynamic substrate. In an embodiment of the invention, the dynamic substrate and the shock protection module are separate components that are coupled together.

An alternate shock protection system comprises a dynamic substrate and a flexure. The dynamic substrate comprises a shock protection module that can contact a flexure in a shock event. For example, in some embodiments, the shock protection module can contact an over mold section of the flexure. The flexure can comprises a dynamic end and a static end, and a shock protection module contacts the static end of the flexure in a shock event.

Alternatively or additionally, a shock protection system can comprise a dynamic substrate and a second stop. The dynamic substrate comprises a soft stop that contacts a second stop in a shock event. In some embodiments the soft stop can be a flexure, and in other embodiments the soft stop can be a protecting coating around at least an impact section of an edge of a scan mirror.

In other embodiments, a shock protection system comprises a dynamic substrate and a static substrate. The dynamic substrate comprises a shock protection module, and the static substrate, comprises at least one stop, which extends through an over mold section of a flexure. In a shock event, the shock protection module contacts the stops and limits the motion of the flexure.

Still in other embodiments, a shock protection system can comprise a dynamic substrate, a non-brittle mirror, and a stop. The non-brittle mirror is coupled to the dynamic substrate, and can be made of a non-brittle material, such as, for example, plastic, tempered glass, polished metal, etc. In a shock event, the non-brittle mirror contacts the stop and impedes motion of the dynamic substrate.

An exemplary scan module can comprise one or more, in any combination, of the exemplary shock protection systems describes above.

Other objects and features of the invention will become apparent from the following detailed description, considering in conjunction with the accompanying drawing figures. It is understood however, that the drawings are designed solely for the purpose of illustration and not as a definition of the limits of the invention.

### BRIEF DESCRIPTION OF THE DRAWING FIGURES

The drawing figures are not to scale, are merely illustrative, and like reference numerals depict like elements throughout the several views.

FIG. 1 illustrates a block diagram of an exemplary device implemented in accordance with an embodiment of the invention.

FIGS. 2 and 3 illustrate three-dimensional views of an exemplary shock protection module implemented in accordance with an embodiment of the invention.

FIG. 4 illustrates a three-dimensional exploded view of an exemplary scan motor implemented in accordance with an embodiment of the invention.

FIG. 5 illustrates a three-dimensional view of an exemplary scan motor implemented in accordance with an embodiment of the invention.

FIG. 6 illustrates a three-dimensional view of an exemplary scan module implemented in accordance with an embodiment of the invention.

FIG. 7 illustrates an exemplary shock protection method implemented according to an embodiment of the invention.

FIG. 8 illustrates a three-dimensional view of an exemplary scan module implemented in accordance with an alternate embodiment of the invention.

FIG. 9 illustrates an exemplary shock protection method implemented according to another embodiment of the invention.

### DETAILED DESCRIPTION OF EXEMPLARY EMBODIMENTS

There will now be shown and described in connection with the attached drawing figures several exemplary embodiments of methods and apparatus for providing a shock protection.

Sometimes scanners are dropped or knocked of tables by accident. Therefore, in order to provide reliable devices, the scanner is designed to withstand shock events. For example, some technical specifications require shock protection from drops of 6 feet or more. The flexure, also known as the spring, that allows movement of the scan mirror, can be overstressed and damaged in a shock event. Therefore, stops are used to control the range of motion of the flexure.

In an embodiment of the invention, the stops are made of a soft material. Elements of the scan module, such as for example, extending members, a scan mirror, etc. can contact the stops in shock events, thus limiting the motion of the flexure and other scan elements. Limiting the motion of the scan elements protects the elements when a device that includes a scan module is dropped. The soft material also acts as a cushion for the scan element that contacts the stop in a fall.

An exemplary scan module can comprise a spring module. The spring module can comprises a static substrate and a dynamic substrate coupled together by at least one flexure. In an embodiment of the invention, the soft stop can be an over mold section of the flexure. A member extending from the dynamic substrate contacts the over mold section in a shock event and limits the motion of the scan elements.

In another embodiment of the invention, stops can extend from the dynamic substrate and through the over mold section of the flexure. In a shock event, the extending members of the dynamic substrate contact the stops, thus limiting motion.

In addition, in other embodiments, the scan mirror can contact a stop in a shock event. In order to protect the mirror, the mirror can be made of a non-brittle material, such as, for example, plastic, tempered glass, polished metal, etc. In other embodiments, the mirror can comprise a protective coating around the edge of the mirror. The protective coating can be made of a soft or hard material. Additionally, in some embodiments, the mirror can have a protective coating only around the sections that contacts stops in shock events.

In alternate embodiments, a scan module can use all, some or one of the shock protection systems described above.

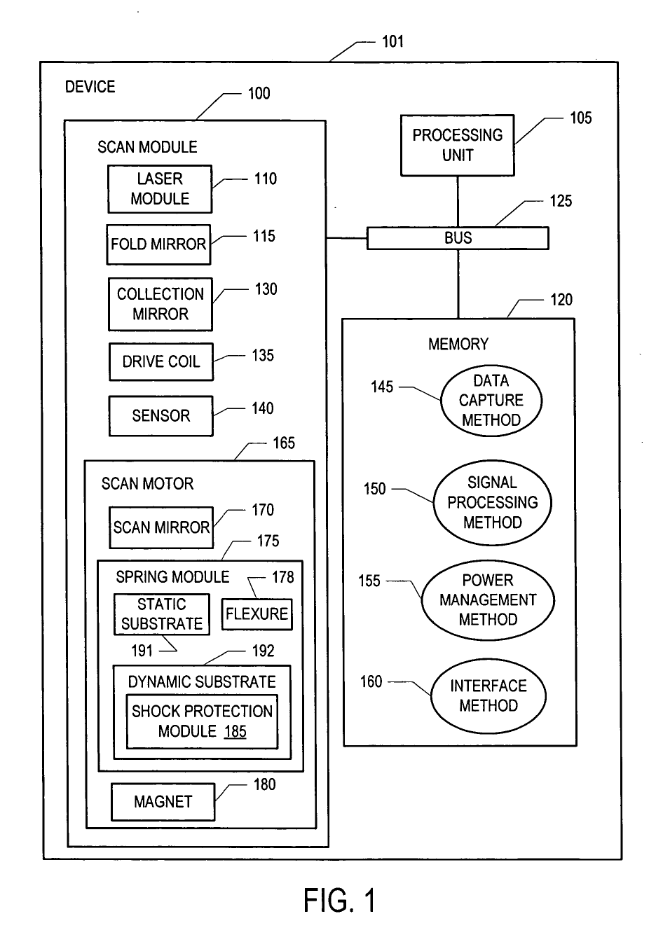

FIG. 1 illustrates an exemplary block diagram of a device 101 comprising a scan module 100, a processing unit 105 and memory 120 coupled together by bus 125. The modules of device 101 can be implemented as any combination of software, hardware, hardware emulating software, and reprogrammable hardware. The bus 125 is an exemplary bus showing the interoperability of the different modules of the invention. As a matter of design choice there may be more than one bus and in some embodiments certain modules may be directly coupled instead of coupled to a bus 125. The device 101 can be, for example, a laser scanner, a mobile computer, a point of sale terminal, etc, and the scan module can be, for example, a retroreflective scan engine.

Processing unit 105 can be implemented as, in exemplary embodiments, one or more Central Processing Units (CPU), Field-Programmable Gate Arrays (FPGA), etc. In an embodiment, the processing unit 105 may comprise a plurality of processing units or modules. Each module can comprise memory that can be preprogrammed to perform specific functions, such as, for example, signal processing, interface emulation, etc. In other embodiments, the processing unit 105 can comprise a general purpose CPU that is shared between the scan engine 100 and the device 101. In alternate embodiments, one or more modules of processing unit 105 can be implemented as an FPGA that can be loaded with different processes, for example, from memory 120, and perform a plurality of functions. Processing unit 105 can also comprise any combination of the processors described above.

Memory 120 can be implemented as volatile memory, non-volatile memory and rewriteable memory, such as, for example, Random Access Memory (RAM), Read Only Memory (ROM) and/or flash memory. The memory 120 stores methods and processes used to operate the device 101, such as, data capture method 145, signal processing method 150, power management method 155 and interface method 160.

In an exemplary embodiment of the invention, the device 101 can be a handheld scanner 101 comprising a trigger. When a scanning operation is initiated, for example the trigger is pressed, the scanner 101 begins data capture method 145. During the data capture method 145, laser light is emitted by the scanner 101, which interacts with a target dataform and returns to the scanner 101. The returning laser light is analyzed, for example, the received analog laser light is converted into a digital format, by the scanner 101 using signal processing method 150. Power management method 155 manages the power used by the scanner 101 and interface method 160 allows the scan engine 100 to communicate with the scanner 101.

The exemplary embodiment of FIG. 1 illustrates data capture method 145, signal processing method 150, interface method 160 and power management method 155 as separate components, but those methods are not limited to this configuration. Each method described herein in whole or in part can be separate components or can interoperate and share operations. Additionally, although the methods are depicted in the memory 120, in alternate embodiments the methods can be incorporated permanently or dynamically in the memory of processing unit 105.

Memory 120 is illustrated as a single module in FIG. 1, but in some embodiments image scanner 100 can comprise more than one memory modules. For example, the methods described above can be stored in separate memory modules. Additionally, some or all parts of memory 120 may be integrated as part of processing unit 105.

Scan module 100 comprises a laser module 110, a fold mirror 115, a collection mirror 130, a drive coil 135, a sensor 140 and a scan motor 165. The scan motor 165 comprises a scan mirror 170, a spring module 175 and a magnet 180. The spring module 175 comprises a static substrate 191 and a dynamic substrate 192 that can be coupled together by a flexure 178. An exemplary static substrate 191 can be, for example, an injection molded thermoplastic material that can be secured to a chassis of a scan engine and remains static with respect to the scan engine. The dynamic substrate 191, i.e., the moving part of the spring module 175, can also be, for example, an injection molded thermoplastic material.

In an embodiment of the invention, the substrates 191, 192 are coupled together by a flexure 178 made of LIM or any other moldable material, such as, for example, silicone. In alternate embodiments, any material that can have flexible properties can be used to make the flexure. The substrates can be coupled together using a multiple shot molding process, such as, for example, an over mold process.

In an alternate embodiment, the dynamic substrate 192 and the flexure 178 can be molded as one piece using the same material. The working portion of the flexure 178 is made sufficiently small and/or thin to improve efficiency and to meet volume requirements of small scan engines. The dynamic substrate 192 also comprises an extending member that extends towards the static substrate 191. In an embodiment, the extending member has a wedge-like shape that grows wider as it extends towards the static substrate 191.

An exemplary scan motor 165 has a scan mirror 170 positioned next to the flexure 178. The extending member of the dynamic substrate 192 receives a scan mirror 170 on a first side and a shock protection module 185 is mounted on a second side. The extending member of the dynamic substrate can comprise a cradle on its first side to receive the scan mirror 170, and the mirror 170 can comprise a receiving structure for coupling to the cradle. A member extending from the shock protection module 185 is positioned to contact an over mold section of the flexure 178 during a shock. Additionally, the shock protection module 185 can help to control the movement of the scan motor 165 during normal operations. In some embodiments, the flexure 178 is made of a soft material, such as, for example, silicone. A soft material can help to cushion the member extending from the shock protection module 185 in a shock event.

In an embodiment, a magnet 180 can be placed in a receiving structure formed by the shock protection module 185 and the dynamic substrate 192. The magnet 180 can be bonded, for example, using an adhesive, to the receiving structure. The angle between the scan mirror 170 and the flexure 178 and between the magnet 180 and the flexure 178 can be manipulated by adjusting the size and/or the angle of inclination of the receiving sides of the wedge shaped extending member. Thus, the plane in which the mirror 170 lies can be at any angle relative to the plane in which the flexure 178 or flexures lie, and the plane in which the magnet 180 lies can also be at any angle relative to the plane in which the flexure 178 or flexures lie.

In exemplary scan module 100, the scan motor 165 can be positioned in close proximity to a drive coil 135, such as, for example, a bi-directional drive coil as described in U.S. Pat. No. 6,824,060, which is owned by the assignee of the instant invention and is incorporated by reference. When powered, the drive coil 135 causes the scan motor 165 to oscillate back and forth. A laser beam impinging on the mirror is then moved back and forth to create a scan line that can be used to read dataforms, such as, for example, barcodes.

The scan motor 165 is properly aligned within the scan module 100 so that the laser beam reflects off the scan motor's mirror and creates a scan line in a desired direction. In an exemplary retroreflective scan module 100, the static substrate 191 comprises a pivoting base that is used to align the scan motor 165. The scan module 100 also comprises a chassis having a feature to receive the pivoting base. After the scan motor 165 is aligned correctly, it can be secured in place using an adhesive. The retroreflective scan module can be, in some embodiments, an independent scan engine that is a module of a scanning device.

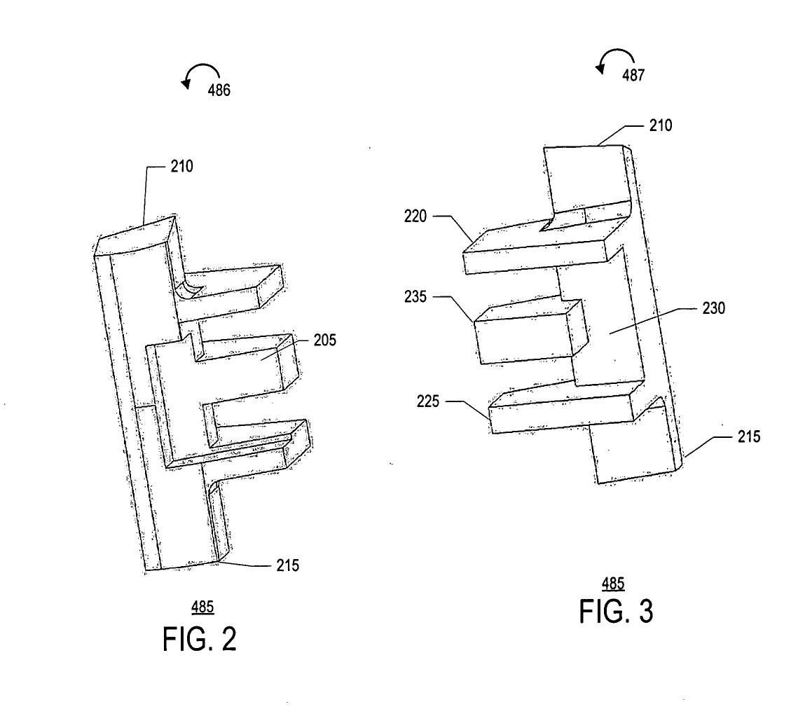

FIGS. 2 and 3 illustrate three-dimensional views of a shock protection module 485, implemented in accordance with an embodiment of the invention, which can be used as shock protection module 185 of FIG. 1. FIG. 2 illustrates a first side 486 that shows a magnet receiving structure 205. When the shock protection module 485 is coupled to the dynamic substrate of a spring module, the receiving structure 205 can hold at least some part of a magnet.

FIG. 3 illustrates a second side 487 of shock protection module 485. The second side 487 comprises a receiving structure 230 formed by walls 220 and 225. Extending from the center of receiving structure 230, between walls 220 and 225 is member 235. Receiving structure 230 couples to the dynamic substrate of a spring module. For example, the dynamic substrate can comprise an extending member that fits between the walls 220, 225 that make the receiving structure 230. For added stability, extending member 235 fits within a receiving slot in the dynamic substrate. Extending from opposite ends of the receiving structures 205, 230 are members 210, 215.

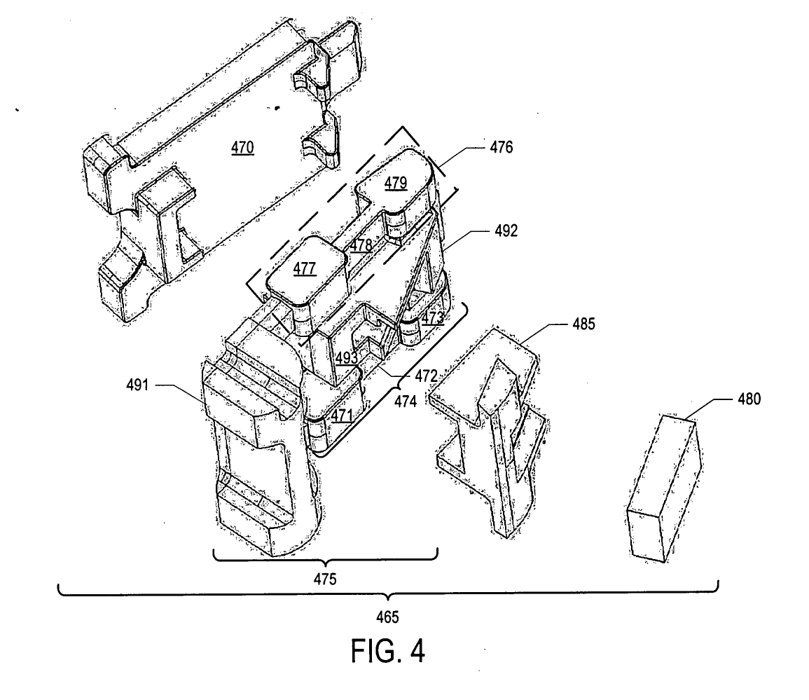

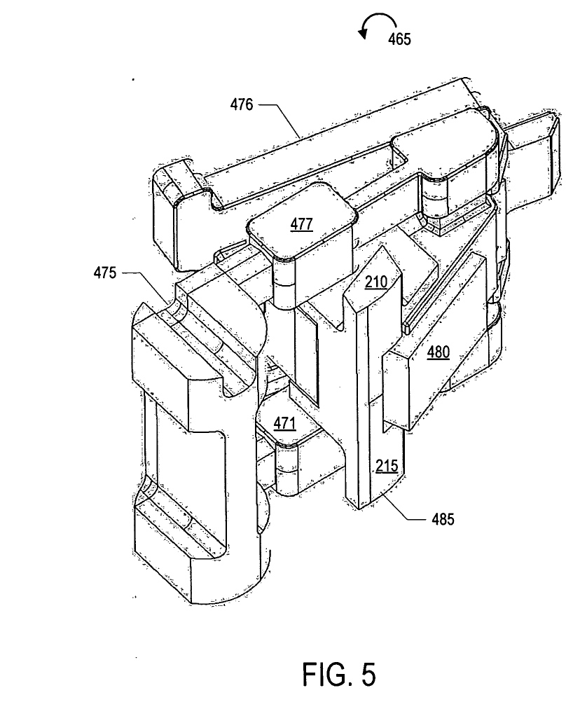

FIGS. 4 and 5 illustrate three-dimensional views of an exemplary scan motor 465, implemented in accordance with an embodiment of the invention. FIG. 4 is an exploded view of the scan motor 465. Scan motor 165 of FIG. 1 can be implemented as exemplary scan motor 465. Scan motor 465 comprises scan mirror 470, spring module 475, shock protection module 485 and magnet 480.

Spring module 475 comprises a static substrate 491 and a dynamic substrate 492, coupled together by flexures 476 and 474. In one exemplary embodiment, static and dynamic substrates 475, 476 are made of a thermoplastic material. The exemplary flexures 476, 474 can be made of silicone and are, in an embodiment, liquid injection molded to the dynamic substrate 491 and the static substrate 492. In alternate embodiments, the flexures 476, 474 can be made of thermoplastic using an injection molding process, or alternatively, the flexures 476, 474 and the dynamic substrate 492 can be made of an LIM material. In an alternate embodiment, the flexures 476, 474 and the dynamic substrate 475 can be molded as one unit that is made of the same material. For example, the combined unit can be made of silicone or thermoplastic. Additionally, while the modules of spring module 475 are four separate components, in alternate embodiments, the spring module can be made as a single piece and any combination of modules can be made as a combined piece.

Static substrate 491 comprises a cylindrically shaped base that can be placed in a cylindrical receiving structure in a scan module chassis. The base can be used to properly align and secure the scan motor 465 to the scan engine chassis 612. Flexures 476, 474 are over molded over two members extend tangentially from both ends of the cylinder. The other end of the flexures 476, 474, which are coupled to the dynamic substrate 492, are over molded over two members extending perpendicularly from said extending member 493. Dynamic substrate 492 also comprises a wedge shaped extending member 493 for receiving a mirror, a shock protection module and a magnet.

The spring module 475 comprises a pair of flexures 476 and 474 that couple the static substrate 491 to the dynamic substrate 492. Flexure 476 comprises two over mold sections 477, 479 and a flexing section 478. Similarly, flexure 474 comprises two over mold sections 471, 473 and a flexing section 472.

FIG. 5 illustrates a three-dimensional view of the scan motor 465. FIG. 5 illustrates the modules of scan motor 465 coupled together as one unit. The members 210, 215 of shock protection module 485 are positioned to contact the over mold sections 477, 471 of the flexures 476, 474 during a shock event.

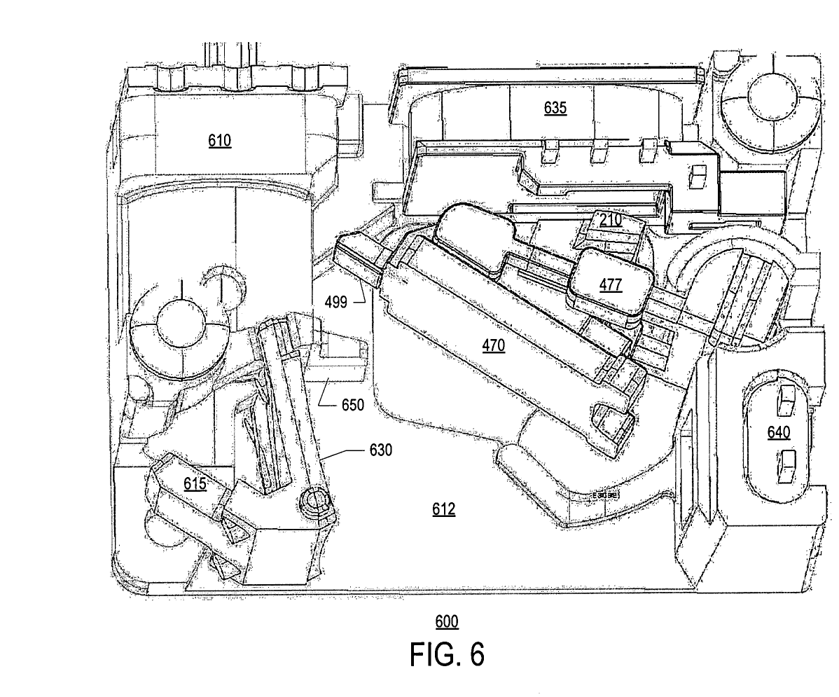

FIG. 6 illustrates a three-dimensional view of a scan engine 600, implemented in accordance with an embodiment of the invention. The scan module 100, illustrated in FIG. 1, can be implemented as the scan engine 600. 1. FIG. 6 illustrates a laser module/assembly 610 positioned in the upper left hand corner of the scan engine chassis 612. During an exemplary operation of data capture method 145, the laser assembly 610 emits a laser beam that is reflected by a fold mirror 615. The reflected laser beam goes through a hole in the collection mirror 630 and impinges on the scan mirror 470. The scan mirror 470 is part of a scan motor 465, which moves back and forth creating a scan line for reading dataforms.

After interacting with a dataform, some of the emitted laser light returns to the scan engine 600. The returning light is received by the scan mirror 470 and is reflected towards the collection mirror 630. The collection mirror 630, which can have a concave shape, such as, for example, an off axis parabola shape, spherical shape, etc., collects the returning light and concentrates it towards the sensor 640. In alternate embodiments, the returning light can be concentrated towards a sensor 640 by a lens. The sensor 640 is positioned in a receiving structure located on the right side of the chassis 612 and in front of the scan motor 465. The sensor 640 can be implemented, in an exemplary embodiment, as a photodiode. The returning light is detected by the sensor 640 which produces a corresponding electrical signal. The electrical signal is analyzed and the target dataform is decoded.

The scan motor 465 is positioned in proximity to the drive coil 635. The magnet 480 coupled to the scan motor 465 interacts with the magnetic field created by the drive coil 635 and oscillates the scan motor 465 when the drive coil 635 is excited.

A printed circuit board (PCB) (not shown) comprising processing units, and interfaces to other devices can be placed on top and on the side of the chassis 612. Exemplary scan engine 600 has an approximate volume of 0.200 in³ and an approximate collection area of 0.050 in².

When a shock even occurs, for example, the device that contains scan engine 600 is dropped, the flexures 475, 476 are protected from over-travel by the members 210, 215. Over-travel can occur in both rotational and lateral movements. If the shock event moves the shock protection module 485 forward, the members 210, 215 contact the over mold section 477, 471 of the flexures 476, 474, and limit the movement of the flexures 476, 474. If the shock protection module 485 moves in a backward direction, the members 210, 215 contact the drive coil 635, and limit the movement of the flexures 476, 474. If the shock protection module 485 moves in an upward direction, the members 210, 215 contact the PCB, and limit the movement of the flexures 476, 474. If the shock protection module 485 moves in a downward direction, the members 210, 215 contact the chassis 612, and limit the movement of the flexures 476, 474. Thus, the members protect the flexures 476, 474, in multiple directions.

In alternate embodiments, when the shock protection module 485 moves in a backward direction the members 210, 215 can contact another mechanical portion of the scan module 600. Additionally, the back of the mirror can contact over mold sections 477, 471 and help to control the movement of the flexures 476 and 474. Alternatively, the scan mirror 470, can comprise an extending member 499, which can contact a stop 650 that extends from the chassis 612. The extending member 499 can be a separate module coupled to the scan mirror 470, or the extending member 499 and the scan mirror 470 can be made as one piece.

In some embodiments of the invention, the scan mirror 470, or just the extending member 499, can be made of a hard, non-brittle material, such as, for example, plastic, tempered glass, polished metal, etc. A non-brittle material is less likely to be damaged if the mirror 470 contacts a stop in a shock event. Alternatively or additionally, the mirror 470 can have a protective coating around its edge or just around the sections that contact stops in a shock event. The coating can be made of a soft material or a hard material.

In other embodiments, the flexures 476 and 474 can be protected from shocks by positioning one ore more stationary stops around the dynamic over mold section 479, 473, of the flexures 476 and 474. In a shock event, the over mold section 479, 473 contacts the stationary stop and limits the movement of the flexures 476 and 474. Further, in alternate embodiments, the members 210, 215 can be position to contact the working portion of the flexures in a shock event.

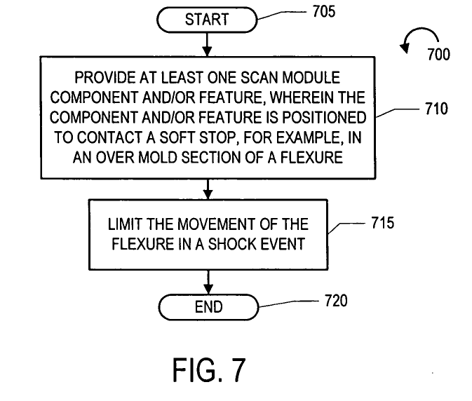

FIG. 7 illustrates an exemplary shock protection method 700, implemented in accordance with the invention. Method 700 starts in step 705 and proceeds to step 710. In step 710, at least one scan module component and/or feature is provided to protect a flexure during a shock event. The component and/or feature can be positioned so that it can contact a soft stop in a shock event. In an embodiment of the invention, the soft stop can be an over mold section of the flexure. Processing then proceeds to step 715, where the component and/or feature limits the movement of the flexure in a shock event.

In an embodiment, the scan module component and/or feature that is provided to protect a flexure during a shock event is a member that extends from a dynamic substrate, and in a shock event, the member moves towards and contacts an over mold section of a flexure. In another embodiment, a stationary stop or stops are placed in proximity to the dynamic end of the flexures. In a shock event, the flexure can move towards and contact the stationary stops.

Still in other embodiments, the scan module component and/or feature is a scan mirror. Thus in a shock event, the scan mirror as opposed to the mirror mount, hits one or more stops. Using the scan mirror to limit movement in a shock event may cause the mirror to break or chip. In order to prevent chipping, the stops can have a soft surface and/or can be made of a flexible material. Alternatively, a soft protective material can be placed around the edge of the mirror to prevent it from chipping. In addition, the mirror can be made of plastic, tempered glass, polished metal or any other non-brittle material that has suitable optical properties. These materials can hit a hard stop without chipping. In some embodiments, a non-brittle mirror can be combined with soft stops. The mirror can also have an extending member that is made of a non-brittle material and is coupled to the mirror.

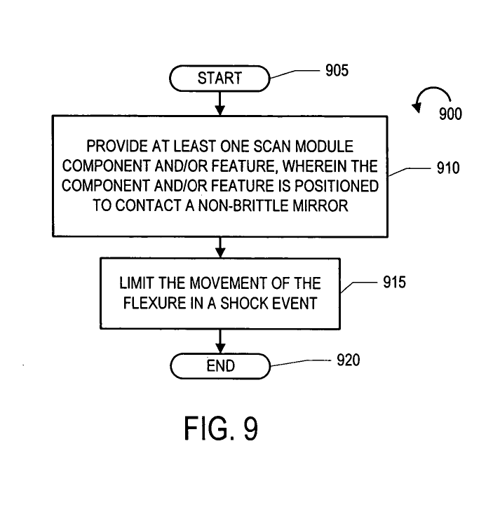

FIG. 9 illustrates an exemplary shock protection method 900, where the scan module component and/or feature contacts a non-brittle mirror in a shock event. Method 900 starts in step 905 and proceeds to step 910. In step 710, at least one scan module component and/or feature is provided to protect a flexure during a shock event. The component and/or feature can be positioned so that it can contact a non-brittle mirror in a shock event. In an embodiment of the invention, the mirror can contact a member extending from the chassis. Processing then proceeds to step 915, where the component and/or feature limits the movement of the flexure in a shock event.

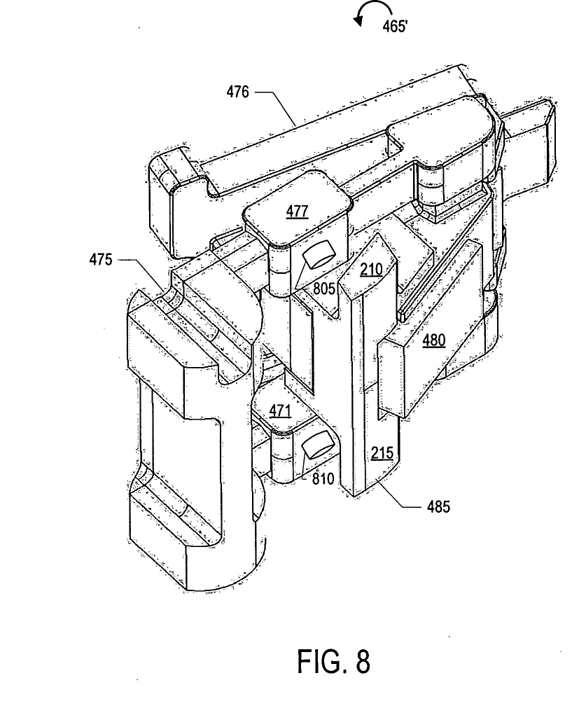

FIG. 8 illustrates an exemplary scan motor 465′. Scan motor 465′ comprises similar components as scan motor 465, illustrated in FIG. 5. In addition to the components of scan motor 465, scan motor 465′ comprises stops 805 and 810. These stops 805, 810 extend from the static substrate 475, though the over mold sections 477, 471 of the flexures 476, 474. In a shock event, the extending members 210, 215 contact the stops 805, 810, which limit the movement of the flexures 476, 474.

While the exemplary shock protection systems of the invention have been described as part of a retoreflective scan system, the systems can also be used in non-retroreflective scan systems. Additionally, the systems are not limited to scanners. Any device that uses flexures and other delicate elements can use similar systems to protect the elements from over-stressed situations.

While there have been shown and described and pointed out fundamental novel features of the invention as applied to preferred embodiments thereof, it will be understood that various omissions and substitutions and changes in the form and detail of the disclosed invention may be made by those skilled in the art without departing from the spirit of the invention. It is the intention, therefore, to be limited only as indicated by the scope of the claims appended hereto.

What is claimed:

1. A shock protection system comprising:
a dynamic substrate, wherein said dynamic substrate comprises a shock protection module; and
a soft stop, wherein said shock protection module contacts said soft stop in a shock event and impedes motion of said dynamic substrate.

2. The shock protection system of claim 1, wherein said dynamic substrate and said shock protection module are separate pieces.

3. The shock protection system of claim 1, wherein said dynamic substrate comprises a receiving structure for receiving at least some part of a magnet.

4. The shock protection system of claim 1, wherein said shock protection module comprises two members extending in opposite directions from said dynamic substrate, and wherein said extending members are positioned a predetermined distance away from at least two stops.

5. The shock protection system of claim 1, wherein said soft stop is a section of a flexure.

6. The shock protection system of claim 5, wherein said soft stop is an over mold section of said flexure, and wherein said flexure is over molded over a static substrate.

7. The shock protection system of claim 5, wherein said soft stop is made of a same material as said flexure.

8. A shock protection system comprising:
a dynamic substrate, wherein said dynamic substrate comprises a shock protection module; and
a flexure, wherein said shock protection module contacts said flexure in a shock event and impedes motion of said dynamic substrate.

9. The shock protection system of claim 8, wherein said flexure is made of silicone.

10. The shock protection system of claim 8, wherein said flexure comprises a dynamic end and a static end, and wherein said shock protection module contacts said static end of said flexure in a shock event.

11. The shock protection system of claim 8, wherein said shock protection module contacts an over mold section of said flexure in a shock event.

12. A shock protection system comprising:
a dynamic substrate, wherein said dynamic substrate comprises a soft stop; and
a second stop wherein said soft stop contacts said second stop in a shock event and impedes motion of said dynamic substrate.

13. The shock protection system of claim 12, wherein said second stop extends from a scan module chassis.

14. The shock protection system of claim 12, wherein the soft stop is a flexure.

15. The shock protection system of claim 14, wherein said soft stop is an over mold section of said flexure, and wherein said flexure is over molded over a dynamic substrate.

16. The shock protection system of claim 14, wherein said flexure comprises a dynamic end and a static end, and wherein said second stop contacts said dynamic end of said flexure in a shock event.

17. The shock protection system of claim 12, wherein said soft stop is a soft coating around at least an impact section of an edge of a scan mirror.

18. A shock protection system comprising:
a dynamic substrate, wherein said dynamic substrate comprises a shock protection module; and
a static substrate, wherein said shock protection module contacts at least one stop extending from said static substrate in a shock event, and wherein said stop extends through an over mold section of a flexure.

19. A shock protection system comprising:
a dynamic substrate;
a non-brittle mirror, wherein said non-brittle mirror is coupled to said dynamic substrate; and
a stop, wherein said non-brittle mirror contacts said stop in a shock event and impedes motion of said dynamic substrate.

20. The shock protection system of claim 19, wherein said non-brittle mirror is made of one of plastic, tempered glass and polished metal.

21. A scan module comprising:
a scan motor, said scan motor comprising:
a static substrate,
a dynamic substrate, said dynamic substrate comprising a shock protection module;
a soft stop coupled to said static substrate, wherein said shock protection module contacts said soft stop in a shock event and impedes motion of said dynamic substrate;
a laser; and
a sensor.

22. The scan module of claim 21, further comprising a flexure coupling said static substrate and said dynamic substrate.

23. The scan module of claim 22, wherein said soft stop is a section of said flexure.

24. The scan module of claim 21, wherein said scan module is enclosed in a housing.

25. The scan module of claim 21, wherein said scan module is an element of a scanner.
